(19) United States
(12) Patent Application Publication
(10) Pub. No.: US 2009/0164215 A1
(43) Pub. Date: Jun. 25, 2009

(54) DEVICE WITH VOICE-ASSISTED SYSTEM

(75) Inventors: Yuan-Chia Lu, Hualien County (TW); Liang-Sheng Huang, Taipei City (TW); Jia-Lin Shen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: DELTA ELECTRONICS, INC., Taoyuan Hsien (TW)

(21) Appl. No.: 12/394,058

(22) Filed: Feb. 27, 2009

Related U.S. Application Data
(63) Continuation-in-part of application No. 10/709,333, filed on Apr. 29, 2004, now Pat. No. 7,499,859.

(30) Foreign Application Priority Data
Feb. 9, 2004 (TW) 93102895

(51) Int. Cl. G10L 17/00; G10L 21/00

(52) U.S. Cl. 704/246; 704/275; 704/E17.001; 704/E21.001

(57) ABSTRACT

A device with a voice-assisted system is provided by using a voice command to adjust operations. The voice-assisted system includes a voice recognition engine and a control device. The voice recognition engine receives a voice command and outputting a voice signal based on the voice command to the control unit. The control unit based on the voice signal adjusts the operations. A user is only required to input the voice command. The voice recognition engine performs a series of actions to adjust the operations. Therefore, the voice-assisted system can enhance convenience of adjusting the operations of the device and reduce operation complexity for the user.

### CROSS-REFERENCE TO RELATED APPLICATION

This application is a continuation-in-part of and claims priority benefit of an application Ser. No. 10/709,333, filed on Apr. 29, 2004, which claims the priority benefit of Taiwan application serial no. 93102895, filed on Feb. 9, 2004. The entirety of each of the above-mentioned patent applications is hereby incorporated by reference herein and made a part of this specification.

### BACKGROUND OF THE INVENTION

1. Field of the Invention

This invention generally relates to a device with a voice-assisted system and a method thereof for adjusting operations, and more particularly to a device based on voice input to adjust the operations and a method thereof.

2. Description of Related Art

As technology advances, electronic appliances in our daily life, automated equipment in working places, and electronic devices for entertainment purposes show that people highly rely on the electronic devices over time.

For the electronic devices that have a plurality of operations, the operations are classified into different categories, so that a user can adjust the operations at will.

FIG. 1 is a conventional method for adjusting the operations of an electronic device. Referring to FIG. 1, there are several levels in a control menu. Even if the user would like to slightly adjust one operation, she/he has to use a button to enter into several levels of architecture in order to reach the very level the operation is located in. For example, when the user wants to adjust one operation, she/he has to push the button to select entering into the second level from the main menu. Then she/he has to set the command in the second level based on what she/he wants to adjust and the menu goes to the third level. Then the user has to do the corresponding action based on the command she/he selected. For example, if the user wants to adjust the brightness, the user has to select “Brightness” in the main menu. Under the directory of “Brightness”, there are two sub-directories “brightness” and “contrast”. After selecting “brightness”, the user finally can adjust the brightness under the sub-directory of “brightness”. In addition, there is no universal standard for classifying the operations. That is, the same operation may be classified into different directories in products manufactured by different companies. For those who are not familiar with the adjustment operation, it is very inconvenient to go through so many levels of directories in order to adjust the operation.

To solve the above problem, it would be helpful for the user to adjust the operation based on voice command. By using a voice command control procedure, the user can make the commands directly to the electronic device so that the electronic device can automatically perform the actions corresponding to the voice commands without pushing any buttons. However, in a conventional voice command control system, a single voice only corresponds to one action. In other words, if the user wants the electronic device to perform a series of actions, she/he has to make several voice commands, which causes a lack of flexibility.

### SUMMARY OF THE INVENTION

An objective of the present invention is to provide a device with a voice-assisted system and a method thereof by using a voice command to adjust operations.

Another objective of the present invention is to provide a device with a voice-assisted system and a method thereof for adjusting the operations so that it is more convenient for a user to adjust the operations without giving a series of commands and worrying about voice recognition error.

The present invention provides a method for adjusting the operations, suitable for adjusting a device with a voice-assisted system, the method comprising: receiving a voice command; recognizing the voice command and outputting a voice signal based on a result of recognizing the voice command; and identifying the voice command as one of a specific command and a fuzzy command based on the voice signal.

According to an embodiment of the present invention, wherein if the voice command is the specific command, the method further comprises adjusting one of the operations corresponding to the voice command.

According to an embodiment of the present invention, if the voice command is the fuzzy command, the method further comprises adjusting a plurality of the operations corresponding to the voice command.

According to an embodiment of the present invention, before the identifying step, the method further comprises: performing a confidence measure of the voice signal, outputting an estimation level based on the confidence measure, and comparing the estimation level with a predetermined estimation threshold. The step of comparing the estimation level with a predetermined estimation threshold includes: if the estimation level is higher than the predetermined estimation threshold, directly going to the step of identifying the voice command as a specific command or a fuzzy command based on the voice signal; if the estimation level is lower than the predetermined estimation threshold, displaying a plurality of commands based on the voice signal; if a similarity between the plurality of commands and the voice signal is higher than a predetermined value, selecting one of the plurality of commands, and going to the step of identifying the voice command as the specific command or the fuzzy command based on the voice signal.

According to an embodiment of the present invention, if the similarity between the plurality of commands and the voice signal is higher than a predetermined value, the step of selecting one of the plurality of commands includes selecting one of the plurality of commands by a voice input or by a button input.

According to an embodiment of the present invention, if the voice command is the fuzzy command, the method further comprises finding the plurality of operations corresponding to the voice command from a command database.

According to an embodiment of the present invention, if the voice command is the fuzzy command, the method further comprises displaying the performed operations corresponding to the voice command.

The present invention provides a device with a voice-assisted system, comprising: a voice recognition engine receiving a voice command and outputting a voice signal based on the voice command; a control device, coupled to the voice recognition engine for receiving the voice signal and identifying the voice command as one of a specific command and a fuzzy command based on the voice signal.

According to an embodiment of the present invention, if the voice command is the specific command, the control device adjusts the operations corresponding to the voice command.

According to an embodiment of the present invention, if the voice command is the fuzzy command, the control device adjusts a plurality of operations corresponding to the voice command.

According to an embodiment of the present invention, the device further comprises a confidence measure unit performing a confidence measure of the voice signal, outputting an estimation level based on the confidence measure, and comparing the estimation level with a predetermined estimation threshold. After comparing the estimation level with the predetermined estimation threshold, if the estimation level is higher than the predetermined estimation threshold, the control device directly identifies the voice command as one of the specific command and the fuzzy command based on the voice signal; if the estimation level is lower than the predetermined estimation threshold, the control device displays a plurality of commands based on the voice signal; if a similarity between the plurality of commands and the voice signal is higher than a predetermined value, the control device selects one of the plurality of commands, and the control device identifies the voice command as one of the specific command and the fuzzy command based on the voice signal.

According to an embodiment of the present invention, if the similarity between the plurality of commands and the voice signal is higher than the predetermined value, the control device selects one of the plurality of commands via a voice input through the voice recognition engine, or via a button input.

According to an embodiment of the present invention, if the voice command is the fuzzy command, the voice recognition engine finds the plurality of operations corresponding to the voice command from a command database.

According to an embodiment of the present invention, if the voice command is the fuzzy command, the control device displays the operations corresponding to the voice command.

The present invention provides a device with a voice-assisted system, comprising: a voice recognition engine receiving and recognizing a voice command and outputting a recognition result, the voice recognition engine including a confidence measure unit performing a confidence measure of the voice signal, outputting an estimation level based on the confidence measure, comparing the estimation level with a predetermined estimation threshold to output a voice signal; a control device, coupled to the voice recognition engine, receiving the voice signal and identifying the voice command as one of a specific command and a fuzzy command based on the voice signal.

According to an embodiment of the present invention, if the voice command is the specific command, the display control unit adjusts an operation corresponding to the voice command.

According to an embodiment of the present invention, if the voice command is the fuzzy command, the display control unit adjusts a plurality of operations corresponding to the voice command.

According to an embodiment of the present invention, the device is a video device.

According to another embodiment of the present invention, the device is an air conditioner.

According to still another embodiment of the present invention, the device is a toy.

According to an embodiment of the present invention, when comparing the estimation level with the predetermined estimation threshold, if the estimation level is higher than the predetermined estimation threshold, the control device directly identifies the voice command as a specific command or a fuzzy command based on the voice signal; if the estimation level is lower than the predetermined estimation threshold, the control device displays a plurality of commands based on the voice signal, and if the similarity between the plurality of commands and the voice signal is higher than a predetermined value, the control device selects one of the plurality of commands, and the control device identifies the voice command as one of the specific command and the fuzzy command based on the voice signal.

According to an embodiment of the present invention, if the similarity between the plurality of commands and the voice signal is higher than a predetermined value, the control device selects one of the plurality of commands via a voice input through the voice recognition engine, or via a button input of the device.

According to an embodiment of the present invention, if the voice command is the fuzzy command, the voice recognition engine finds the plurality of operations corresponding to the voice command from a command database.

According to an embodiment of the present invention, if the voice command is the fuzzy command, the control device displays adjusted operations corresponding to the voice command. After displaying the performed plurality of operations corresponding to the voice command, the user may choose to further modify the adjusted operations using an adjustment modification process.

The device with a voice-assisted system and the method thereof for adjusting images of the present invention can use a single voice command to perform the adjustments. Hence, it is more convenient for the users to operate. Further, when the user gives the voice command but the device does not act responsive to the voice command, the present invention can make the device perform a series of actions for adjusting the operations by analyzing and comparing the voice command. After performing the adjustments, those actions performed by the device will be shown for the user to fine-tune the adjustments. Hence, the method for adjusting operations of the present invention is more flexible than the conventional method and thus can effectively reduce the operation complexity for the users.

In addition, because the voice-assisted system of the present invention includes a confidence measure unit to evaluate the recognition result performed by the voice recognition engine, it can prevent wrong actions due to the low recognition rate so that the reliability of the system can be significantly improved.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF THE DRAWINGS

FIG. 1 is a conventional method for adjusting operations of an electronic device.

FIG. 2 is block diagram of a device with a voice-assisted system according to an embodiment of the present invention.

FIG. 3 a flowchart showing a method for adjusting operations according to an embodiment of the present invention.

FIG. 4 is a block diagram of a video device with a voice-assisted system according to an embodiment of the present invention.

FIG. 5 is a block diagram of an air conditioner with a voice-assisted system according to another embodiment of the present invention.

FIG. 6 is a block diagram of a toy with a voice-assisted system according to still another embodiment of the present invention.

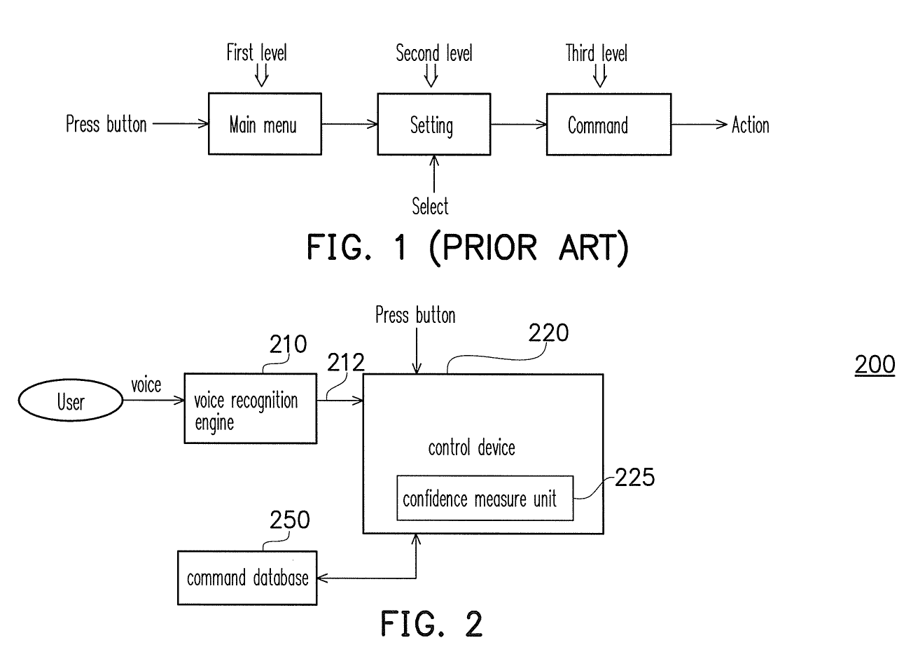

### DESCRIPTION OF THE EMBODIMENTS

The present invention provides a device with a voice-assisted system and a method thereof for adjusting operations. Unlike conventional art, the device with the voice-assisted system and the method thereof are more convenient for the user to adjust the operations without giving a series of commands and worrying about voice recognition error.

The device with the voice-assisted system of the present invention comprises a voice recognition engine and a control device. The voice recognition engine receives a voice command from the user and outputs a voice signal based on the voice command to the control device. The control device is coupled to the voice recognition engine.

The method for adjusting the operations via the device with a voice-assisted system comprises: receiving the voice command from the user; recognizing the voice command and outputting the voice signal based on a result of recognizing the voice command; and identifying the voice command as a specific command or a fuzzy command based on the voice signal. If the voice command is the specific command, one of the operations corresponding to the voice command is adjusted. If the voice command is the fuzzy command, a plurality of the operations corresponding to the voice command is adjusted. Further, if the adjusted operations do not meet the user's expectation, the user can further modify the operations using an adjustment modification process. A process of modifying the operations can be performed by another voice command or button command.

In the method for adjusting the operations via the device with the voice-assisted system of the present invention, the specific command means a specific operating action. This operating action can adjust a specific category of the device. The specific category can be stored in, for example, the voice recognition engine or the control device, depending on design requirements. If this specific command, for example, is “increase brightness”, then this specific command can directly adjust the brightness of the device.

In the method for adjusting the operations via the device with a voice-assisted system of the present invention, the fuzzy command means adjusting the plurality of operations. The operations can be stored in the voice recognition engine, the control device, or an independent command database, depending on the design requirements. According to an embodiment of the present invention, the series of operations can also be adjusting the device in a plurality of steps.

FIG. 2 is block diagram of a device with a voice-assisted system according to an embodiment of the present invention. Referring to FIG. 2, a device 200 comprises a voice recognition engine 210 and a control device 220. The voice recognition engine 210 is coupled to the control device 220.

When the user gives a voice command, the voice recognition engine 210 recognizes the voice command. After recognition, the voice recognition engine 210 outputs a voice signal 212 to the control device 220 based on a recognition result. When the control device 220 receives the voice signal 212, it performs subsequent adjustments to the operations. The voice signal 212 is transmitted to the control device 220 via wired transmission or wireless transmission. According to an embodiment of the present invention, the device 200 further includes a command database 250 coupled to the control device 220. The control device 220 obtains information for adjusting the operations corresponding to the voice signal 212 from the command database 250. The command database 250 may also be coupled to the voice recognition engine 210 according to the design requirements.

The method for adjusting the operations via the device with the voice-assisted system of the present invention can use a structure of the device 200 as shown in FIG. 2.

On the other hand, when the voice recognition engine 210 determines that the voice signal 212 is a fuzzy command, the control device 220 analyzes and compares the command, and then refers to the command set stored in the command database 250 in order to generate a series of commands. The display control unit 230 then adjusts the plurality of operations based on the series of commands.

It should be noted that currently voice recognition technology still cannot reach a 100% recognition rate. Hence, according to an embodiment of the present invention and referring to FIG. 2, a confidence measure unit 225 can selectively be added to the control device 220 or to the voice recognition engine 210 for evaluating the recognition result in order to raise reliability of the system. Referring to FIG. 2, the confidence measure unit 225 is included in the control device. The function and the purpose of the confidence measure unit 225 are described as follows.

Referring to FIG. 2, according to an embodiment of the present invention, the confidence measure unit 225 can be designed into the control device 220. The voice recognition engine 210 will output the recognition result “score” to the control device 220 via the voice signal 212. The confidence measure unit 225 then evaluates the recognition result from the voice recognition engine 210 and outputs an estimation level corresponding to the recognition result. The estimation level is compared to the estimation threshold. The estimation level represents the similarity between the recognition result and the corresponding voice signals in the command database.

If the estimation level is higher than the estimation threshold, the control device 220 determines whether the voice command is a specific command or a fuzzy command. If it is a specific command, the display control unit 230 subsequently adjusts the operation corresponding to this specific command.

If the estimation level is lower than the estimation threshold, the control device 220 displays several similar recognition results previously inputted by the user (i.e., the recognition results having higher similarity to this command) for the user's choice. The user can give a voice command or press the button to select the correct recognition result. The present invention is not limited these two methods of selection. After the user makes the selection, if the voice command is a specific command, the operation corresponding to this specific command is subsequently adjusted. If it is a fuzzy command, the control device 220 will find, from the command database 250, the command set corresponding to the fuzzy command. Then the subsequent operations corresponding to this fuzzy command are performed.

In light of the above, the device with a voice-assisted system can easily adjust the operations. The method for adjusting operations by using the voice-assisted system will be described as follows.

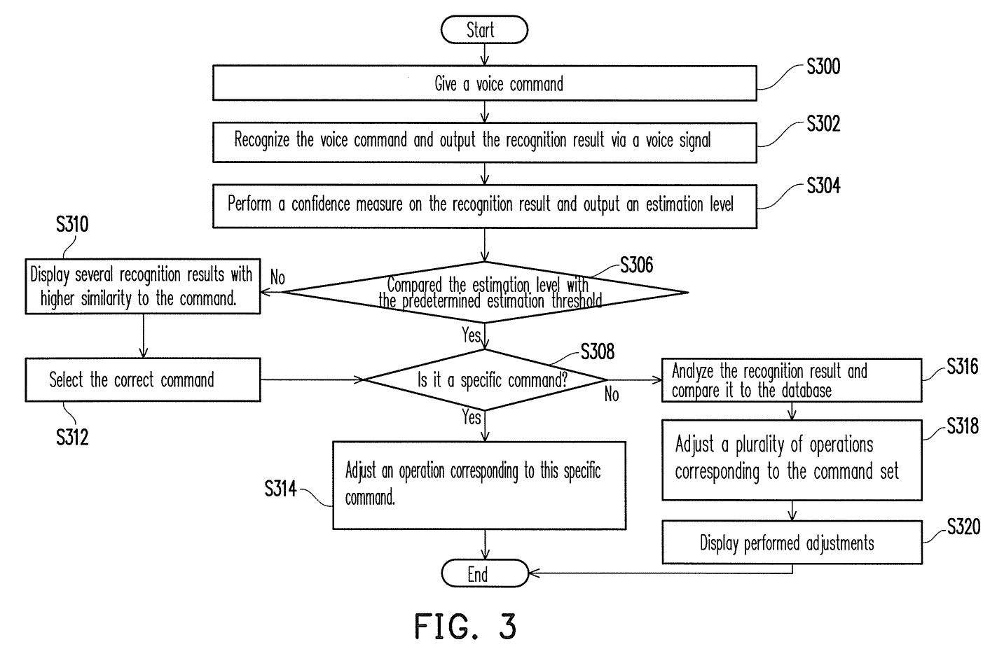

FIG. 3 a flowchart showing a method for adjusting operations according to an embodiment of the present invention. First, the user gives a voice command (S300). Then, the voice command is recognized and the recognition result is outputted via the voice signal (S302). After that, the confidence measure on the recognition result is performed and the estimation level is outputted (S304). Then the estimation level is compared to the predetermined estimation threshold (S306).

If the estimation level is higher than the estimation threshold, then the system will directly determine whether the voice command is a specific command (S308). If the estimation level is lower than the estimation threshold, then the system will display the several similar recognition results previously inputted by the user (i.e., the recognition results having higher similarity to this command) for the user's choice (S310). The user then selects the correct command (S312) and the flowchart goes to S308. If the recognized command (by the system) or selected command (by the user) is a specific command, the system adjusts the operation corresponding to this specific command. (S314).

If the recognized command (by the system) or selected command (by the user) is not a specific command, the recognition result will be analyzed and compared to the database to find the command set corresponding to the plurality of operations (S316). Then the system adjusts the plurality of operations corresponding to this command set (S318). The system then displays the performed operations (S320). The user can accept the adjusted operations or can further adjust the operations based on the performed operations.

It should be noted that in the step S312, the user can give the voice command or press the button to select the correct command. However, the present invention is not limited to those two methods of selection.

In step S308, if it is determined that the recognition result is the specific command, the system adjusts the subsequent operation corresponding to this specific command (S314). On the other hand, in step S308, if it is determined that the recognition result is the fuzzy command, then the recognition result will be analyzed and compared to the database to find the command set corresponding to the plurality of operations (S316). Then the system subsequently adjusts the operations corresponding to this command se. (S318). The system then displays the performed adjustments (S320). If the adjustments do not meet the user's expectation, the user can further modify the adjustments using an adjustment modification process.

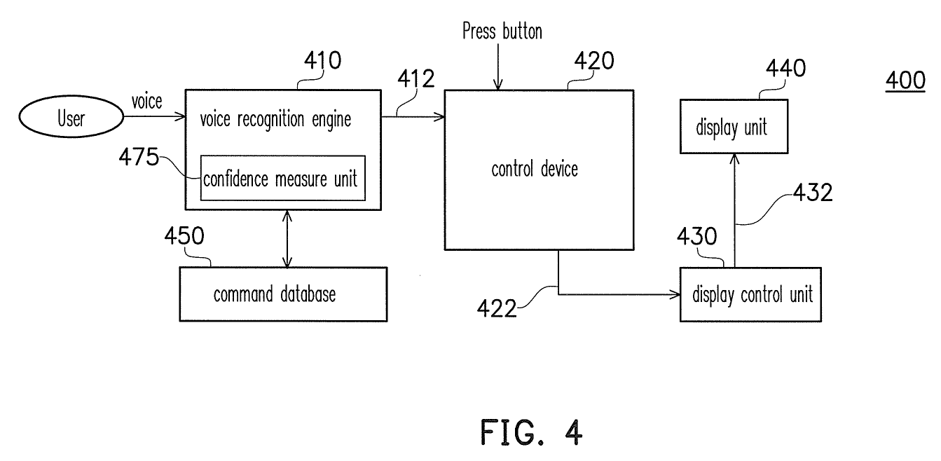

According to an embodiment of the present invention, the device of the present invention is a video device. Referring to FIG. 4, which is a block diagram of a video device with a voice-assisted system according to an embodiment of the present invention, a video device 400 comprises a voice recognition engine 410, a control device 420, a display control unit 430 and a display unit 440. The voice recognition engine 410 is coupled to the control device 420. The display control unit 430 is coupled to the control device 420. The display control unit 430 controls the display of the display unit 440.

A confidence measure unit 475 is designed in the voice recognition engine 410, but the present invention is not limited to an above configuration, meaning that the confidence measure unit 475 may also be included in the control device 420. The voice recognition engine 410 directly evaluates the recognition result “score” via the confidence measure unit 475 and outputs the estimation level. The estimation level is then compared to the estimation threshold. The estimation level represents the similarity between the recognition result and the corresponding voice signal in the command database. If the estimation level is higher than the estimation threshold, then whether the voice command is a specific command or a fuzzy command is determined. If it is a specific command, for example, “increase the contrast to 60%”, then the command is sent to the control device 420 via a voice signal 412 and the control device adjusts the contrast to 60% corresponding to the voice signal 412 using the display control unit 430. The voice signal 412 is transmitted to the control device 420 via wired transmission or wireless transmission.

If the estimation level is lower than the estimation threshold, then voice recognition engine 410 via the control device 420 and the display control unit 430 displays on the display unit 440 several similar recognition results previously inputted by the user (i.e., the recognition results having higher similarity to the voice command) for the user's choice. The user can give a voice command or press the button to select the correct recognition result. The present invention is not limited those two methods of selection.

After the user makes the selection, if the voice command is the fuzzy command, for example “the image is blurry”, the voice signal 412 is sent to the control device 420 to find, from the command database 450, the command set corresponding to the fuzzy command. Then the display control unit 430 performs the subsequent operations, for example adjusting the contrast, brightness, color, and the size of the image corresponding to this fuzzy command.

In light of the above, the video device with the voice-assisted system can easily adjust the images. Hence, it is more convenient for the users to operate. Further, when the user gives the voice command but the video device does not act responsive to the voice command, the present invention can make the video device perform a series of actions for adjusting the images by analyzing and comparing the voice command. After adjusting the images, those actions performed by the device will be shown on the screen for the user to fine-tune the image parameters. Hence, the present invention is more flexible than the conventional method and thus can effectively reduce complexity during usage.

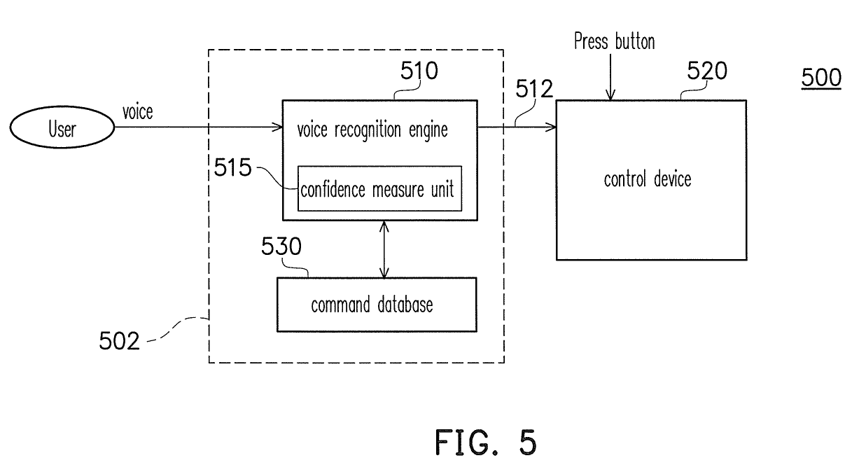

According to another embodiment of the present embodiment, the device is an air conditioner. Referring to FIG. 5, which is a block diagram of an air conditioner with a voice-assisted system according to another embodiment of the present invention, an air conditioner 500 comprises a voice recognition engine 510, a control device 520 and a command database 530. The voice recognition engine 510 is coupled to the control device 520, while the command database 530 can be coupled to the voice recognition engine 510 or the control device 520, or to both. The voice recognition engine 510 or the control device 520 further includes a confidence measure unit 515. Referring to FIG. 5, the confidence measure unit 515 is included in the voice recognition engine 510, but the confidence measure unit 515 may also be included in the control device 520. A remote control 502 of the air conditioner includes the voice recognition engine 510, the confidence measure unit 515 and the command database 530. Alternatively, the remote control 502 may only include the voice recognition engine 510 and the confidence measure unit 515, while the command database 530 is coupled to the control device 520, or the remote control 502 may solely include the voice recognition engine 510. The estimation level is compared to the estimation threshold. The estimation level represents the similarity of recognition result to the corresponding voice signals in the command database. If the estimation level is higher than the estimation threshold, then it determines whether it is a specific command or a fuzzy command. If it is a specific command, then the command is sent to the control device 520 via a voice signal 512, and the control device 520 adjusts the subsequent operation corresponding to the voice signal 512. The voice signal 512 is transmitted to the control device 520 via wired or wireless transmission.

If the estimation level is lower than the estimation threshold, then the control device 520 displays several similar recognition results previously inputted by the user (i.e., the recognition results having higher similarity to this command) for the user's choice. The user can give a voice command and press the button to select the correct recognition result. The present invention is not limited those two methods of selection.

After the user makes the selection, if the voice command is a fuzzy command, for example “the air is stifling”, the voice signal 512 is sent to the control device 520 to find, from the command database 530, the command set corresponding to the fuzzy command. Then the control device 520 performs the subsequent adjustment actions corresponding to this fuzzy command, for example adjusting temperature, adjusting humidity and adjusting a direction of a wind outlet or any combination of the above. In addition to adjusting the temperature, adjusting the humidity and adjusting the direction of the wind outlet, other operations that may be adjusted include adjusting a wind speed, adjusting a duration during which the air conditioner is turned on, and any combination of the above.

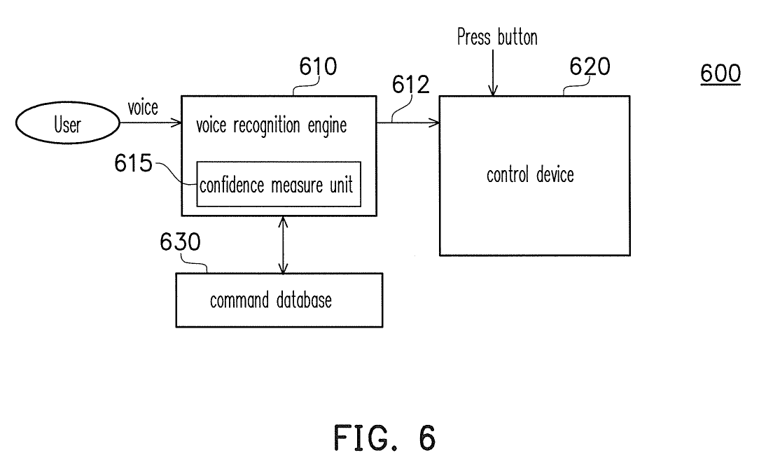

According to still another embodiment of the present embodiment, the device is an air conditioner. Referring to FIG. 6, which is a block diagram of a toy with a voice-assisted system according to still another embodiment of the present invention, an air conditioner 600 comprises a voice recognition engine 610, a control device 620 and a command database 630. The voice recognition engine 610 is coupled to the control device 620, while the command database 630 can be coupled to the voice recognition engine 610 or the control device 620, or to both. The voice recognition engine 610 or the control device 520 further includes a confidence measure unit 615, but the present invention is not limited to an above configuration, meaning that the confidence measure unit 615 may be included in the control device 620. Referring to FIG. 6, the confidence measure unit 615 is included in the voice recognition engine 610. The estimation level is compared to the estimation threshold. The estimation level represents the similarity of the recognition result to the corresponding voice signals in the command database. If the estimation level is higher than the estimation threshold, then it determines whether it is a specific command or a fuzzy command. If it is a specific command, then the command is sent to the control device 620 via a voice signal 612, and the control device adjusts the subsequent operation corresponding to the voice signal 612. The voice signal 612 is transmitted to the control device 620 via wired transmission or wireless transmission.

If the estimation level is lower than the estimation threshold, then the control device 620 displays several similar recognition results previously inputted by the user (i.e., the recognition results having higher similarity to this command) for the user's choice. The user can give a voice command and press the button to select the correct recognition result. The present invention is not limited those two methods of selection.

After the user makes the selection, if the voice command is a fuzzy command, for example “it is boring”, the voice signal 612 is sent to the control device 620 to find, from the command database 630, the command set corresponding to the fuzzy command. Then the control device 620 performs the subsequent adjustment actions corresponding to this fuzzy command, for example performing changes to expression, singing and dancing.

In addition, because the voice-assisted system of the present invention includes a confidence measure unit to evaluate the recognition result performed by the voice recognition engine, that is, to reassure the accuracy of the voice command. Hence, it can prevent wrong actions due to the low recognition rate so that the reliability of the system can be significantly improved.

The above description provides a full and complete description of the preferred embodiments of the present invention. Various modifications, alternate construction, and equivalents may be made by those skilled in the art without changing the scope or spirit of the invention. Accordingly, the above description and illustrations should not be construed as limiting the scope of the invention which is defined by the following claims.

What is claimed is:

1. A method for adjusting operations of a device with a voice-assisted system, said method comprising:
receiving a voice command;
recognizing said voice command and outputting a voice signal based on a result of recognizing said voice command; and
identifying said voice command as one of a specific command and a fuzzy command based on said voice signal, wherein if said voice command is identified as said fuzzy command, using said fuzzy command to adjust a plurality of operations of said device corresponding to said voice command.

2. The method of claim 1, if said voice command is said specific command, further comprising adjusting an operation corresponding to said voice command.

3. The method of claim 1, before the step of identifying said voice command, further comprising: performing a confidence measure of said voice signal, outputting an estimation level based on said confidence measure, and comparing said estimation level with a predetermined estimation threshold.

4. The method of claim 3, wherein the step of performing the confidence measure comprises:
if said estimation level is higher than said predetermined estimation threshold, directly going to said step of identifying said voice command as the specific command or the fuzzy command based on said voice signal;
if said estimation level is lower than said predetermined estimation threshold, displaying a plurality of commands based on said voice signal, and when a similarity between said plurality of commands and said voice command is higher than a predetermined value, selecting one of said plurality of commands, and performing said step of identifying said voice command as one of said specific command and said fuzzy command based on said voice signal.

5. The method of claim 4, wherein said step of selecting one of said plurality of commands includes selecting one of said plurality of commands by a voice input.

6. The method of claim 4, wherein said step of selecting one of said plurality of commands includes selecting one of said plurality of commands by a button input from said device.

7. The method of claim 1, if said voice command is said fuzzy command, further comprising finding said plurality of operations corresponding to said voice command from a command database.

8. The method of claim 1, if said voice command is said fuzzy command, further comprising displaying performed adjustments corresponding to said voice command.

9. The method of claim 8, after said step of displaying said performed adjustments corresponding to said voice command, further comprising an adjustment modification process.

10. The method of claim 9, wherein said adjustment modification process comprises selection by a voice input.

11. The method of claim 9, wherein said adjustment modification process comprises selection by a button input.

12. A device with a voice-assisted system, comprising:
a voice recognition engine receiving a voice command and outputting a voice signal based on said voice command; and
a control device, coupled to said voice recognition engine, which receives said voice signal, and identifies said voice command as one of a specific command and a fuzzy command, wherein if said voice command is identified as said fuzzy command, using said fuzzy command to adjust a plurality of operations of said device corresponding to said voice command.

13. The device of claim 12, wherein if said voice command is said specific command, said control device adjusts an operation corresponding to said voice command.

14. The device of claim 12, further comprising a confidence measure unit performing a confidence measure of said voice signal, outputting an estimation level based on said confidence measure, and comparing said estimation level with a predetermined estimation threshold.

15. The device of claim 14 wherein when comparing said estimation level with said predetermined estimation threshold,
if said estimation level is higher than said predetermined estimation threshold, said control device directly identifies said voice command as one of the specific command and the fuzzy command based on said voice signal;
if said estimation level is lower than said predetermined estimation threshold, said control device displays a plurality of commands based on said voice signal, and when a similarity between said plurality of commands and said voice command is higher than a predetermined value, said control device selects one of said plurality of commands, and said control device identifies said voice command as one of said specific command and said fuzzy command based on said voice signal.

16. The device of claim 15, wherein said control device selects one of said plurality of commands when said similarity between said plurality of commands and said voice command is higher than the predetermined value, via a voice input through said voice recognition engine.

17. The device of claim 15, wherein said control device selects one of said plurality of commands when said similarity between said plurality of commands and said voice command is higher than a predetermined value, via a button input of said device.

18. The device of claim 14, wherein said confidence measure unit is disposed in said control device.

19. The device of claim 14, wherein said confidence measure unit is disposed in said voice recognition engine.

20. The device of claim 12, wherein if said voice command is said fuzzy command, said voice recognition engine finds said plurality of operations corresponding to said voice command from a command database.

21. The device of claim 12, if said voice command is said fuzzy command, said control device displays performed adjustments corresponding to said voice command.

22. The device of claim 21, wherein after displaying said performed adjustments corresponding to said voice command, said control device performs an adjustment modification process.

23. The device of claim 22, wherein said adjustment modification process includes said voice recognition engine selecting via a voice input.

24. The device of claim 22, wherein said adjustment modification process includes selection by a button input.

25. The device of claim 12, wherein the device is a video device.

26. The device of claim 12, wherein the device is an air conditioner.

27. The device of claim 12, wherein the device is a toy.

28. A device with a voice-assisted system, comprising:
a voice recognition engine receiving and recognizing a voice command and outputting a recognition result, said voice recognition engine including a confidence measure unit performing a confidence measure of said voice signal, outputting an estimation level based on said confidence measure, comparing said estimation level with a predetermined estimation threshold to output a voice signal;
a control device, coupled to said voice recognition engine, which receives said voice signal, and identifies said voice command as one of a specific command and a fuzzy command, wherein if said voice command is identified as said fuzzy command, using said fuzzy command to adjust a plurality of operations of said device corresponding to said voice command, wherein said operations desired to be adjusted are based on the comparison result between said estimation level and said predetermined estimation threshold.

29. The device of claim 28, wherein when comparing said estimation level with said predetermined estimation threshold,
if said estimation level is higher than said predetermined estimation threshold, said control device directly identifies said voice command as one of the specific command and the fuzzy command based on said voice signal;
if said estimation level is lower than said predetermined estimation threshold, said control device displays a plurality of commands based on said voice signal, and when a similarity between said plurality of commands and said voice command is higher than a predetermined value, said control device selects one of said plurality of commands, and said control device identifies said voice command as one of said specific command and said fuzzy command based on said voice signal.

30. The device of claim 29, wherein said control device selects one of said plurality of commands, when said similarity between said plurality of commands and said voice command is higher than a predetermined value, via a voice input through said voice recognition engine.

31. The device of claim 29, wherein said control device selects one of said plurality of commands, when said similarity of said plurality of commands to said voice command is higher than the predetermined value, via a button input of said device.

32. The device of claim 28, wherein if said voice command is said fuzzy command, said voice recognition engine finds said plurality of operations corresponding to said voice command from a command database.

33. The device of claim 28, if said voice command is said fuzzy command, said control device displays performed adjustments of said plurality of operations corresponding to said voice command.

34. The device of claim 33, wherein after displaying said performed adjustments of said plurality of operations corresponding to said voice command, said control device performs an adjustment modification process.

35. The device of claim 34, wherein said adjustment modification process comprises said voice recognition engine selecting via a voice input.

36. The device of claim 34, wherein said adjustment modification process includes selection by a button input.

37. The device of claim 28, wherein the device is a video device.

38. The device of claim 28, wherein the device is an air conditioner.

39. The device of claim 28, wherein the device is a toy.
